(19) United States
(12) Patent Application Publication
(10) Pub. No.: US 2026/0231965 A1
(43) Pub. Date: Aug. 13, 2026

(54) Meat Slicer

(71) Applicant: Renhao JIN, Ningbo (CN)

(72) Inventor: Renhao JIN, Ningbo (CN)

(21) Appl. No.: 19/645,496

(22) Filed: Apr. 13, 2026

Related U.S. Application Data
(63) Continuation-in-part of application No. 19/011,204, filed on Jan. 6, 2025, now Pat. No. 12,654,349.
Application No. 19/011,204 is a continuation of application No. PCT/CN2024/090023, filed on Apr. 26, 2024.

(30) Foreign Application Priority Data
Jul. 13, 2023 (CN) 202321844700.X
Jul. 13, 2023 (CN) 202321852848.8
Dec. 15, 2023 (CN) 202323428113.5
Dec. 25, 2023 (CN) 202323548641.4
Dec. 25, 2023 (CN) 202323559966.2
Apr. 11, 2025 (CN) 202520686804.5
Apr. 11, 2025 (CN) 202520687140.4
Aug. 18, 2025 (CN) 202521757086.2
Aug. 18, 2025 (CN) 202521774107.1

(51) Int. Cl. A22C 17/00; B26B 3/04; B26B 29/06

(52) U.S. Cl. CPC A22C 17/0033; B26B 3/04; B26B 29/063

(57) ABSTRACT

A meat slicer includes a model and a blade set. The model has a placement cavity. Opposite side walls and a bottom of the placement cavity include blade grooves in one-to-one correspondence. The blade set includes a plurality of blades arranged side by side and at intervals. The blades can simultaneously insert into the blade grooves on the side walls. The blades travel downward into the blade grooves on the bottom to cut meat in the placement cavity. In case that the blade set travels downward to a position where a part of the blades abuts the model and cannot move further downward, cutting edges of another part of the blades are suspended in the blade grooves on the bottom.

### RELATED APPLICATIONS

This application is a continuation-in-part of U.S. patent application Ser. No. 19/011,204, filed on Jan. 6, 2025, which is a bypass continuation of International Application No. PCT/CN 2024/090023, filed on Apr. 26, 2024, in USPTO, which claims priority to and the benefit of Chinese Patent Application Nos. 2023218528488, filed on Jul. 13, 2023; 2023234281135, filed on Dec. 15, 2023; 202321844700X, filed on Jul. 13, 2023; 2023235599662, filed on Dec. 25, 2023; and 2023235486414, filed on Dec. 25, 2023, and this application also claims priority to and the benefit of Chinese Patent Application No. 202520687140.4, filed on Apr. 11, 2025; Chinese Patent Application No. 202520686804.5, filed on Apr. 11, 2025; Chinese Patent Application No. 202521774107.1, filed on Aug. 18, 2025; and Chinese Patent Application No. 202521757086.2, filed on Aug. 18, 2025, in CNIPA. The contents of all the above-identified applications are incorporated herein by reference in their entireties.

### TECHNICAL FIELD

The present disclosure relates to a meat cutting apparatus, and in particular to a meat slicer capable of cutting meat into slices or shreds.

### BACKGROUND

A meat slicer previously proposed by the applicant comprises a blade set and a model for accommodating meat. The blade set comprises a handle and a blade holder connected to the handle. The blade holder carries a plurality of elongated blades arranged side by side at intervals. The model has a placement cavity with an open top. Two opposite side walls of the placement cavity are each provided with a plurality of first blade grooves having upper end notches and arranged side by side at intervals. During use, meat is placed into the placement cavity, and each blade can enter a corresponding first blade groove and slide back and forth, thereby cutting the meat into slices or shreds. Further improvement of this meat cutter can enhance its safety.

### BRIEF DESCRIPTION OF DRAWINGS

FIG. 1 is a perspective view of a meat slicer according to aspects of the present disclosure.

FIG. 2 is a perspective view showing a blade set of FIG. 1, which contacts a stop block of a model of the meat slicer.

FIG. 3 is a sectional view of FIG. 2.

FIG. 4 is an enlarged view of area A of FIG. 3.

FIG. 5 is a schematic view of the stop block of the model of FIG. 1.

FIG. 6 is a perspective view of a model of a meat slicer according to aspects of the present disclosure.

FIG. 7 is a schematic view of a stop block of the model of FIG. 6.

FIG. 8 is a schematic view of a stop block according to aspects of the present disclosure.

FIG. 9 is a bottom view of a housing of a model according to aspects of the present disclosure.

FIG. 10 is a schematic view of a stop block of FIG. 9.

FIG. 11 is a sectional view of a blade set according to aspects of the present disclosure.

FIG. 12 is a perspective view of a blade set according to aspects of the present disclosure.

FIG. 13 is another perspective view of the blade set of FIG. 12.

FIG. 14 is a sectional view taken along line A-A of FIG. 13, showing a first handle and a second handle in a locked state.

FIG. 15 is a sectional view taken along line A-A of FIG. 13, showing the first handle and the second handle in an unlocked state.

FIG. 16 is a sectional view taken along line C-C of FIG. 13.

FIG. 17 is a perspective view showing a first blade holder and a second blade holder of the blade set of FIG. 12 in a separated state.

FIG. 18 is another perspective view showing the first blade holder and the second blade holder of the blade set of FIG. 12 in a separated state.

### DETAILED DESCRIPTION

The present disclosure is further described in detail below in conjunction with the embodiments of the accompanying drawings.

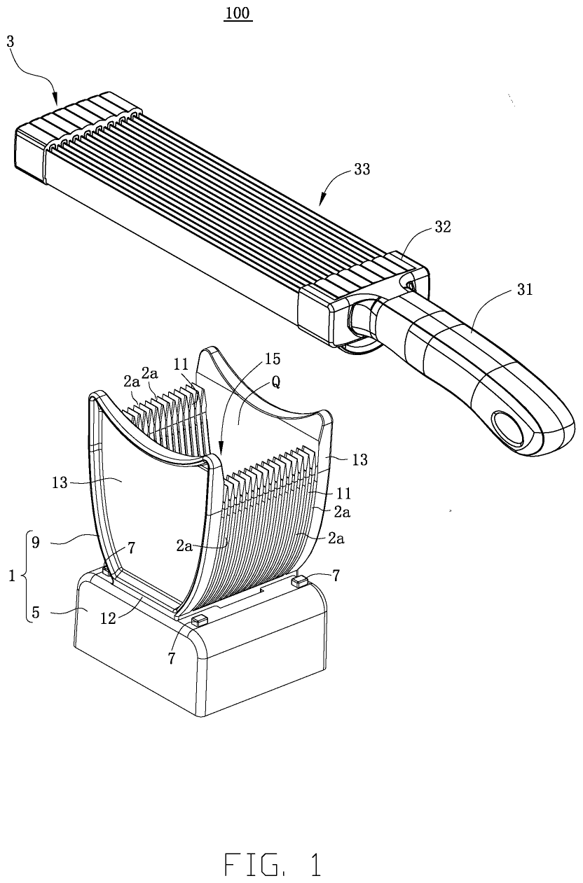

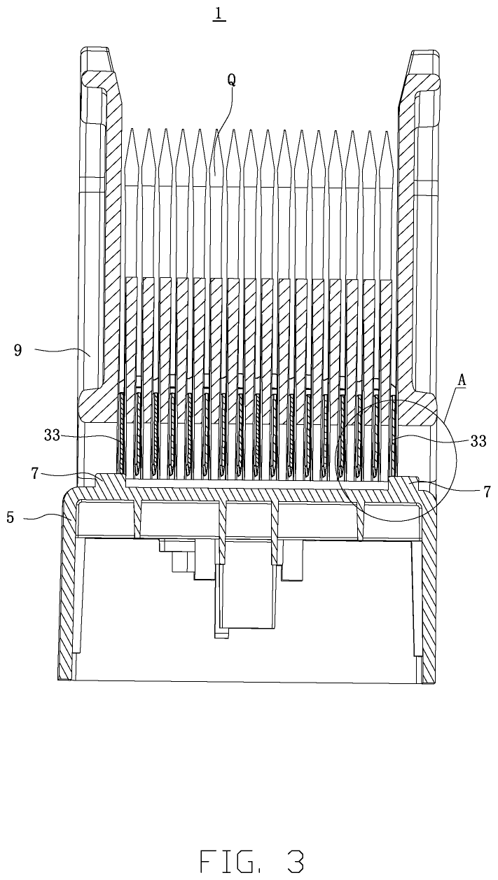

As shown in FIGS. 1 to 5, the meat slicer 100 includes a blade set 3 and a model 1. The blade set 3 cooperates with the model 1 to cut meat into uniform slices or strips. The model 1 is configured to place and position the meat to be cut, and includes a placement cavity Q for accommodating meat. The placement cavity Q has an open top 15. The model 1 includes a bottom 12, two opposite side walls 11 (which may be referred to as a first side wall and a second side wall, respectively), and two shielding walls 13 (which may be referred to as a first shielding wall and a second shielding wall, respectively). The two side walls 11 are arranged in a front-rear direction. The two shielding walls 13 are arranged in a left-right direction. The bottom 12, the two side walls 11 and the two shielding walls 13 are connected. The bottom 12, the two side walls 11 and the two shielding walls 13 together enclose the placement cavity Q.

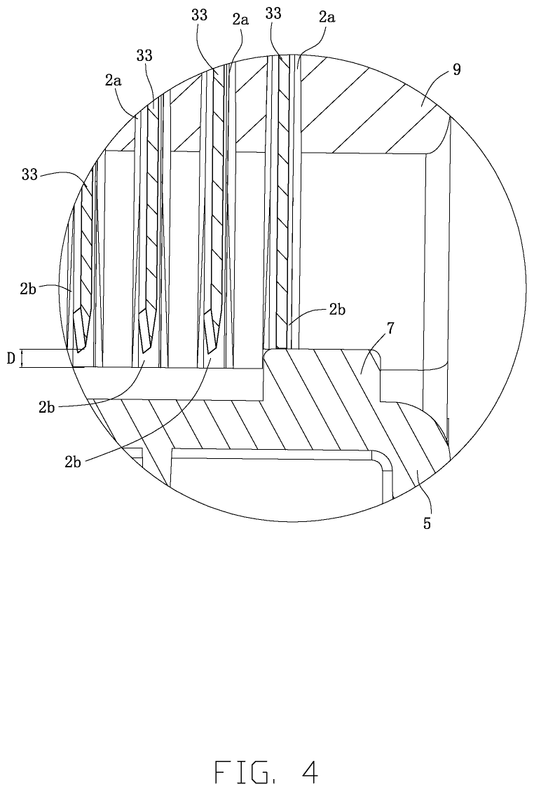

Referring also to FIG. 4, each of the two opposite side walls 11 of the placement cavity Q includes a plurality of first blade grooves 2a. The first blade grooves 2a are arranged side by side and at intervals. The bottom 12 of the placement cavity Q includes a plurality of second blade grooves 2b. The second blade grooves 2b are arranged side by side and at intervals. The second blade grooves 2b correspond to the first blade grooves 2a. The second blade grooves 2b communicate with the first blade grooves 2a. Each of the plurality of second blade grooves 2b extends through at least a portion of the bottom 12 of the model 1 along a thickness direction of the bottom 12 of the model 1. Further, each of the plurality of second blade grooves 2b penetrates through the entire thickness of the bottom 12 of the model 1 to form a through hole 2b1. The through hole 2b1 makes rinsing the model 1 more convenient.

The blade set 3 includes a handle 31. The handle 31 includes a first handle 31a. The blade set 3 also includes a plurality of elongated blades 33. The blades 33 are arranged on the blade set 3. When using the blade set 3 to cut meat in the placement cavity Q, the blades 33 enter the first blade grooves 2a. The first handle 31a drives the blades 33 to slide back and forth. The sliding cuts the meat in the placement cavity Q. The blades 33 can also enter the second blade grooves 2b from the first blade grooves 2a. Thus, all of the blades 33 together first enter the first blade grooves 2a on the side walls 11, and then together enter the second blade grooves 2 b on the bottom 12.Thus the blades 33 can cut through the meat in the placement cavity Q.

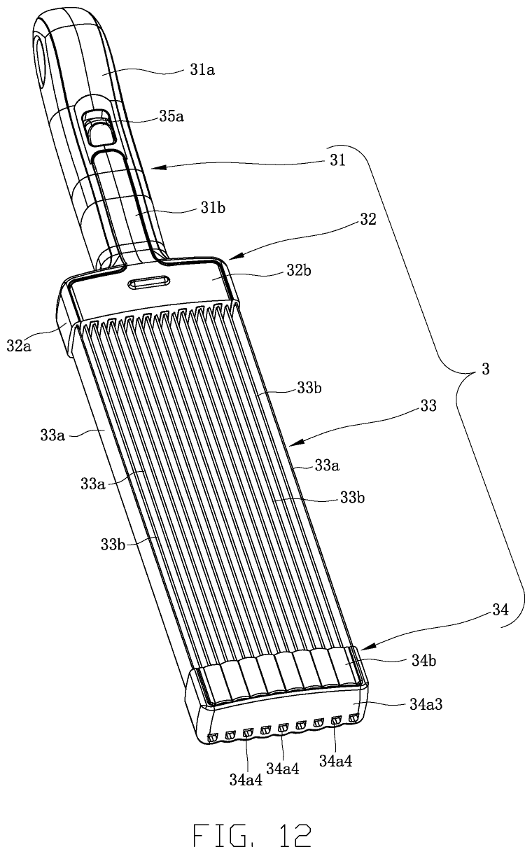

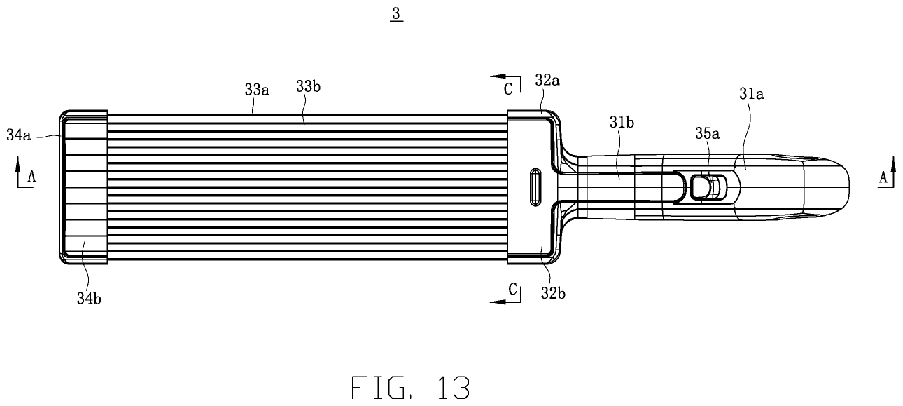

Referring to FIGS. 12 and 13, the longitudinal central axes of the blade set 3, the first handle 31a, and the second handle 31b coincide with each other. In addition to the blades 33 and the first handle 31a, the blade set 3 further includes a blade holder 32, a connecting block 34, and a second handle 31b. The blade holder 32 includes a first blade holder 32a and a second blade holder 32b. The connecting block 34 includes a first connecting block 34a and a second connecting block 34b. The first handle 31a connects to the first blade holder 32a. The second handle 31b connects to the second blade holder 32b. The first blade holder 32a and the second blade holder 32b engage with each other. The first connecting block 34a and the second connecting block 34b engage with each other.

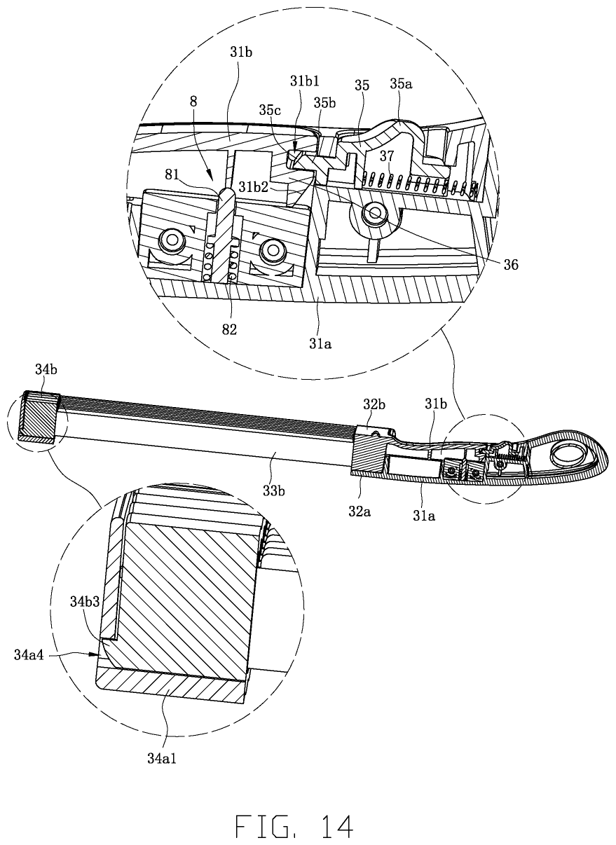

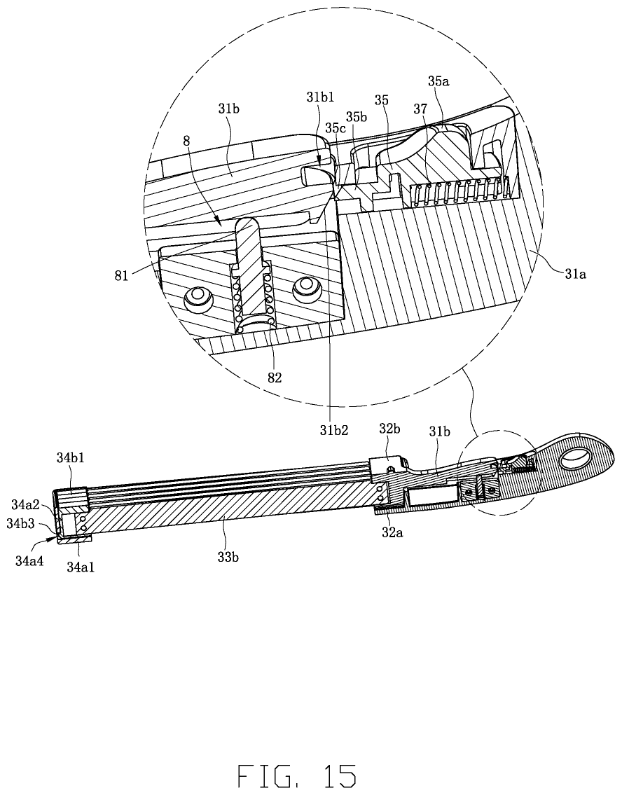

Referring to FIGS. 14 and 15, an outer wall 34a3 of the first connecting block 34a includes a plurality of insertion holes 34a4. A front end of the second connecting block 34b includes a plurality of insertion posts 34b3. In the engaged state, the insertion posts 34b3 insert into the insertion holes 34a4.

Referring to FIG. 12, the blades 33 includes a first set of blades 33a and a second set of blades 33b. The first set of blades 33a and the second set of blades 33b are parallel to each other. Proximal ends of the first set of blades 33a fix to the first blade holder 32a. Distal ends of the first set of blades 33a fix to the first connecting block 34a. Proximal ends of the second set of blades 33b fix to the second blade holder 32b. Distal ends of the second set of blades 33b fix to the second connecting block 34b.

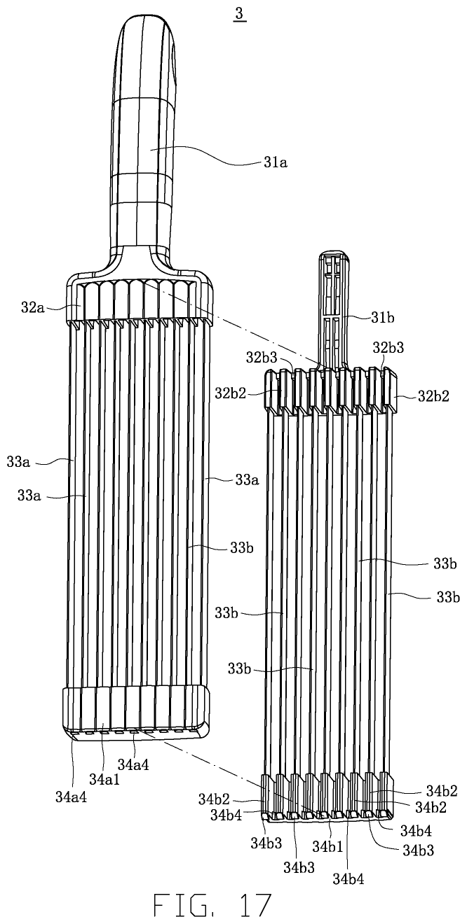

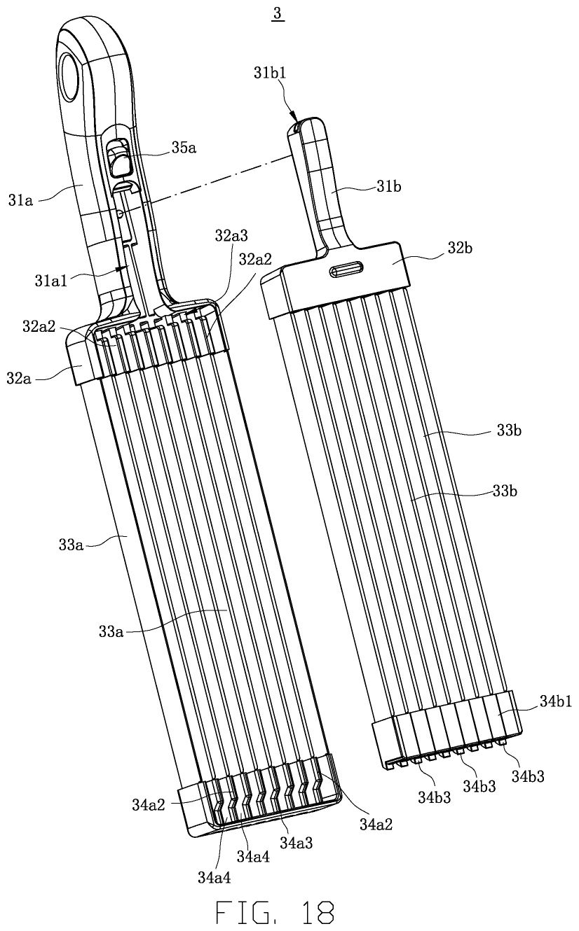

Referring to FIGS. 17 and 18, the blade set 3 includes two modes of use. In a first mode, only the first set of blades 33a is used to cut meat in the placement cavity Q. The first mode produces thicker slices. In a second mode, the first set of blades 33a and the second set of blades 33b are used together to cut meat in the placement cavity Q. The second mode produces thinner slices. In both modes, a user can hold the first handle 31a to operate the blade set 3 to cut meat in the placement cavity Q.

Referring to FIG. 18, the first handle 31a includes a recess 31a1. In a state where the second blade holder 32b engages with the first blade holder 32a, the second handle 31b is received in the recess 31a1. Each blade of the second set of blades 33b is positioned between two adjacent blades of the first set of blades 33a. The second handle 31b can be detached from the recess 31a1. The detachment separates the second blade holder 32b from the first blade holder 32a.

Referring to FIG. 14, a locking block 35 is located inside the first handle 31a. The locking block 35 can slide back and forth along the length direction of the first handle 31a. A front end of the locking block 35 includes a locking tab 35b. The second handle 31b includes a locking hole 31b1 and a locking hook 36. The locking tab 35b is insertable into the locking hole 31b1 to press and lock the locking hook 36, thereby locking the first handle 31a and the second handle 31b to each other. In case that the locking tab 35b withdraws from the locking hole 31b1, the locking tab 35b releases the locking hook 36, thereby unlocking the first handle 31a and the second handle 31b from each other.

Referring to FIG. 14, the locking tab 35b includes a first guiding bevel 35c. The second handle 31b includes a second guiding bevel 31b2. The second guiding bevel 31b2 cooperates with the first guiding bevel 35c. The first guiding bevel 35c and the second guiding bevel 31b2 allow the locking tab 35b to slide more smoothly into the locking hole 31b1. The cooperation achieves automatic locking when the first blade holder 32a and the second blade holder 32b are engaged. The operation is simple and convenient.

Referring to FIGS. 12, 13 and 14, the locking block 35 further includes a driving portion 35a. The driving portion 35a protrudes from the first handle 31a. Pushing the driving portion 35a rearward withdraws the locking tab 35b from the locking hole 31b1. A first elastic member 37 (e.g., a first spring) is further located on the first handle 31a. Two ends of the first elastic member 37 respectively abut the first handle 31a and the locking block 35. The first elastic member 37 biases the locking block 35 to always have a forward sliding tendency. Thus the locking tab 35b extends into the locking hole 31b1 to achieve locking.

Referring to FIG. 14, a pop-up structure 8 is further located in the recess 31a1. The pop-up structure 8 includes a pop-up block 81 and a second elastic member 82 (e.g., a second spring). The pop-up block 81 is constrained inside the first handle 31a. The pop-up block 81 can move up and down along the thickness direction of the first handle 31a. A lower end of the second elastic member 82 abuts the first handle 31a. An upper end of the second elastic member 82 acts on the pop-up block 81. After the locking tab 35b withdraws from the locking hole 31b1, the pop-up block 81 can push the second handle 31b out of the recess 31a1.

The pop-up structure 8 includes two states.

In a first state, as shown in FIG. 14, the first handle 31a and the second handle 31b are locked to each other. The pop-up block 81 is pressed down by the second handle 31b. The second elastic member 82 is compressed. Because the second handle 31b is locked in the recess 31a1 of the first handle 31a, the second elastic member 82 cannot move the pop-up block 81 upward.

In a second state, as shown in FIG. 15, the first handle 31a and the second handle 31b are unlocked from each other. The locking between the second handle 31b and the first handle 31a is released. The pop-up block 81 moves upward under the action of the second elastic member 82. The pop-up block 81 pushes the second handle 31b out of the recess 31a1.

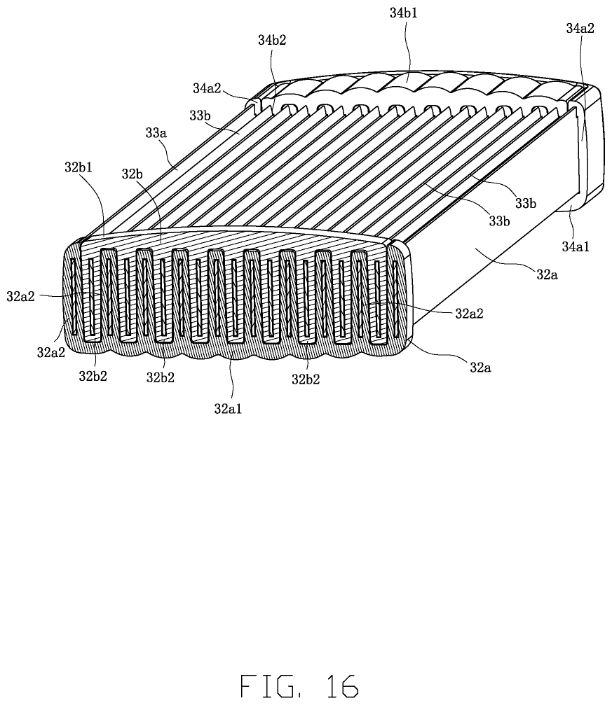

Referring to FIGS. 16, 17 and 18, the first blade holder 32a includes a first lower end surface 32a1 and a plurality of first upper ribs 32a2. The plurality of first upper ribs 32a2 are located on the first lower end surface 32a1. The first upper ribs 32a2 extend upward. The first upper ribs 32a2 are spaced apart in the left-right direction. The second blade holder 32b includes a first upper end surface 32b1 and a plurality of first lower ribs 32b2. The plurality of first lower ribs 32b2 are spaced apart. Each first lower rib 32b2 inserts between two adjacent first upper ribs 32a2. The insertion achieves engagement of the first blade holder 32a and the second blade holder 32b. The proximal end of each blade of the first set of blades 33a fixes to a corresponding first upper rib 32a2. The proximal end of each blade of the second set of blades 33b fixes to a corresponding first lower rib 32b2.

When a user desires to change the cutting mode, for example, to cut thicker slices using only the first set of blades 33a, the user pushes the driving portion 35a. The pushing moves the locking block 35 rearward. The locking tab 35b withdraws from the locking hole 31b1. The pop-up structure 8 pushes the second handle 31b out of the recess 31a1. Then the user grasps the ejected second handle 31b. The user can then separate the second blade holder 32b from the first blade holder 32a.

To cut thinner slices, the user holds the second handle 31b. The user places the second handle 31b into the recess 31a1. The placement engages the second blade holder 32b with the first blade holder 32a. The second handle 31b provides a reliable gripping portion. The second handle 31b makes the use of the blade set 3 safer and more convenient.

Referring to FIGS. 16, 17 and 18, the first connecting block 34a includes a second lower end surface 34a1 and a plurality of second upper ribs 34a2. The plurality of second upper ribs 34a2 are located on the second lower end surface 34a1. The second upper ribs 34a2 extend upward. The second upper ribs 34a2 are spaced apart in the left-right direction. The second connecting block 34b includes a second upper end surface 34b1 and a plurality of second lower ribs 34b2. The second lower ribs 34b2 extend downward from the second upper end surface 34b1. The second lower ribs 34b2 are spaced apart in the left-right direction. Each second lower rib 34b2 inserts between two adjacent second upper ribs 34a2. The insertion achieves engagement of the first connecting block 34a and the second connecting block 34b. The distal end of each blade of the first set of blades 33a fixes to a corresponding second upper rib 34a2. The distal end of each blade of the second set of blades 33b fixes to a corresponding second lower rib 34b2.

As shown in FIGS. 17 and 18, a first reinforcing rib 32b3 is located between two adjacent first lower ribs 32b2. Correspondingly, two adjacent first upper ribs 32a2 includes a first relief groove 32a3. The first relief groove 32a3 accommodates the first reinforcing rib 32b3. The accommodation allows engagement of the first blade holder 32a and the second blade holder 32b. Moreover, a second reinforcing rib 34b4 is located between two adjacent second lower ribs 34b2. Correspondingly, two adjacent second upper ribs 34a2 includes a second relief groove 34a4. The second relief groove 34a4 accommodates the second reinforcing rib 34b4. The accommodation allows engagement of the first connecting block 34a and the second connecting block 34b. The first reinforcing rib 32b3 enhances the structural strength of the second blade holder 32b. The second reinforcing rib 34b4 enhances the structural strength of the second connecting block 34b. The enhancement prevents excessive deformation of the second blade holder 32b and the second connecting block 34b due to thermal expansion and contraction when the second blade holder 32b and the second connecting block 34b are dried after washing.

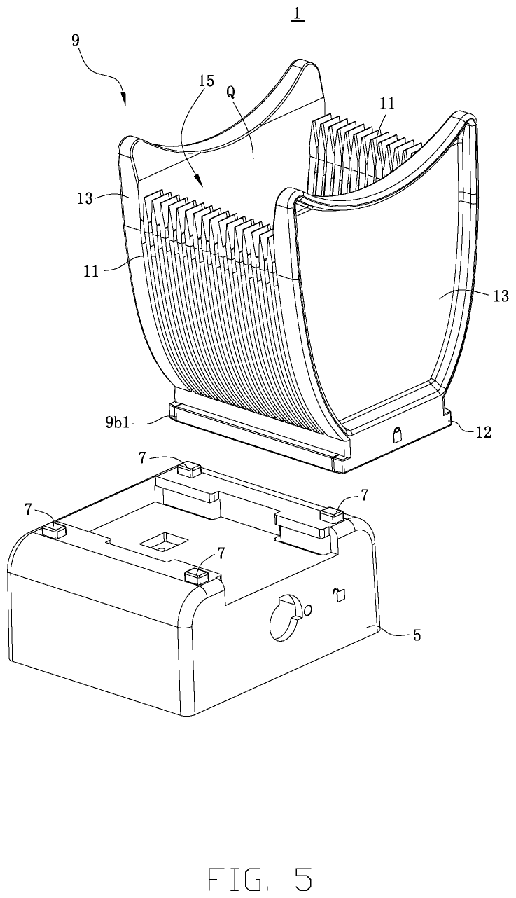

Referring to FIG. 1, the model 1 includes a base 5 and a housing 9. The housing 9 is configured to be mounted on the base 5. Referring to FIG. 5, the housing 9 includes the bottom 12, the two side walls 11 and the two shielding walls 13. The base 5 supports the model 1 on a support surface, such as a tabletop.

In case that the model 1 is made of plastic, plastic debris may be generated when the blades 33 of the blade set 3 cut into the model 1. To reduce such plastic debris, the present disclosure provides various solutions. The solutions work as follows. When the blade set 3 moves downward from the first blade grooves 2a of the housing 9, a part of the blades 33 contacts (or abuts) a structure on the model 1. The part of the blades 33 cannot move further downward. Then the cutting edges of another part of the blades 33 are suspended in the corresponding second blade grooves 2b of the bottom 12. Because the cutting edges of the another part of the blades 33 are suspended in the second blade grooves 2b, the generation of plastic debris is reduced. Specifically, at least one of the following two solutions can be used to suspend the cutting edges of the another part of the blades 33 in the second blade grooves 2b.

In a first solution, the blades 33 of the blade set 3 are divided into two parts. One part serves as limiting blades. The other part serves as cutting blades. The cutting blades includes cutting edges on one side. In case that the cutting edges of the cutting blades face horizontally downward, the horizontal height of the cutting edges of the cutting blades is higher than the horizontal height of the corresponding same side edges of the limiting blades. The first solution works as follows. When the blade set 3 moves downward from the first blade grooves 2a, the bottom portions of the limiting blades contact a lower structure of the model 1. The contact prevents the cutting edges of the cutting blades from contacting the lower structure of the model 1. A gap D (see FIG. 4) remains between the cutting edges of the cutting blades 33 and the bottoms of the second blade grooves 2b. At this time, the cutting edges of the cutting blades are suspended in the second blade grooves 2b. Thus the cutting blades generate less plastic debris when the cutting blades cut meat in the placement cavity Q.

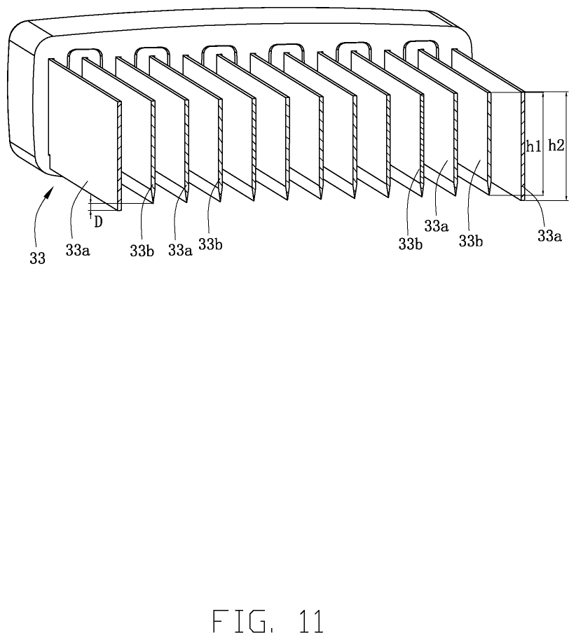

In the above first solution, the number of limiting blades can be one or more. In case that the number of limiting blades is two or more, the limiting blades can be located on both sides of the cutting blades. All the cutting blades are located between the limiting blades. For example, referring to FIG. 11, the two outermost blades 33a on the left and right sides of the blade set 3 serve as limiting blades (two in number). The remaining blades 33 serve as cutting blades. Thus all cutting blades are located between the two limiting blades. Because the horizontal height of the cutting edges of the cutting blades is higher than the horizontal height of the corresponding same side edges of the limiting blades, the cutting edges of the cutting blades are hidden upward. The hiding better prevents injury and makes use safer. The hiding also facilitates determining the assembly positions of the limiting blades.

In the above first solution, the limiting blades are elongated. The limiting blades can be made of metal or non-metal. The limiting blades may include cutting edges. Alternatively, the limiting blades may include no cutting edges. In case that the limiting blades include cutting edges, the cutting edges of the limiting blades and the cutting edges of the cutting blades are located on the same side of the blade set 3. Moreover, in case that the limiting blades include cutting edges, when the edge of the limiting blade comprising the cutting edge is in a horizontal state, the side of the limiting blade opposite the cutting edge is at the same horizontal level as the corresponding side of the cutting blade. As shown in FIG. 11, the two outermost blades of the blade set 3 belong to the first set of blades 33a. The two outermost blades serve as limiting blades. The remaining blades 33 of the blade set 3 serve as cutting blades. The height h2 of the limiting blades is greater than the height h1 of the cutting blades. Moreover, the cutting edges of the limiting blades may be less sharp than the cutting edges of the cutting blades. Thus when the cutting edges of the limiting blades contact the model 1, the cutting strength of the limiting blades against the model 1 is reduced. The reduction reduces plastic debris generated by contact between the limiting blades and the model 1.

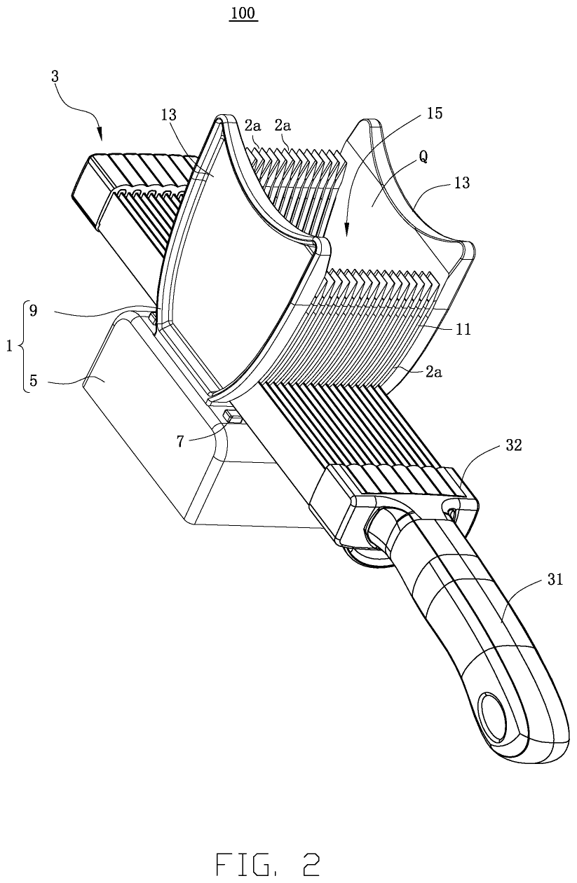

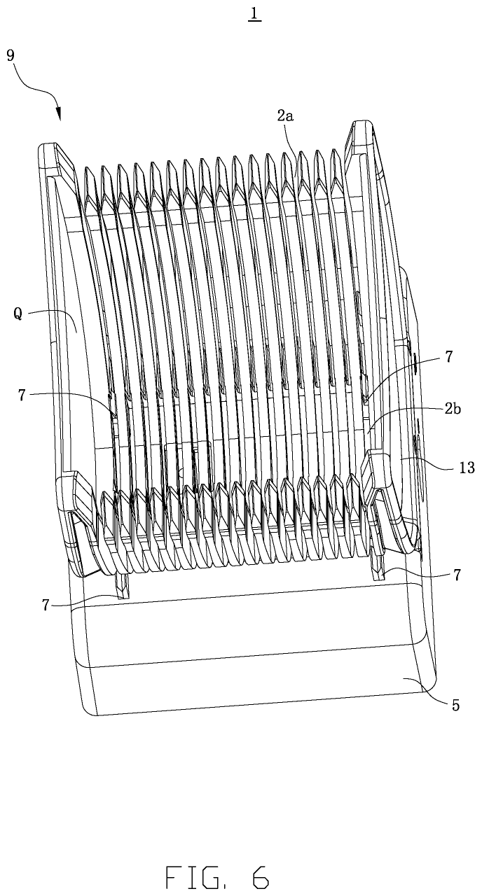

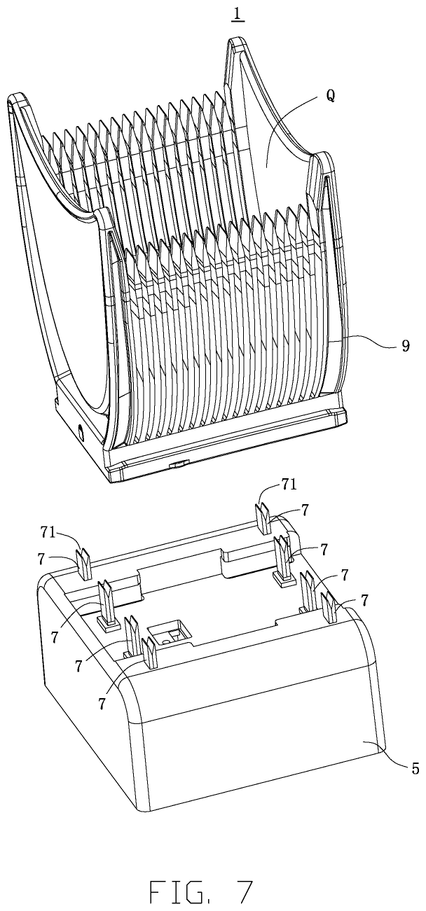

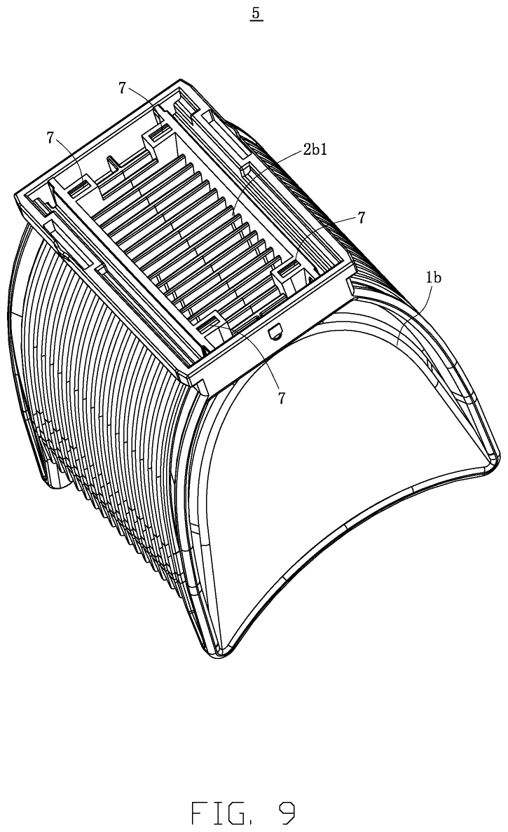

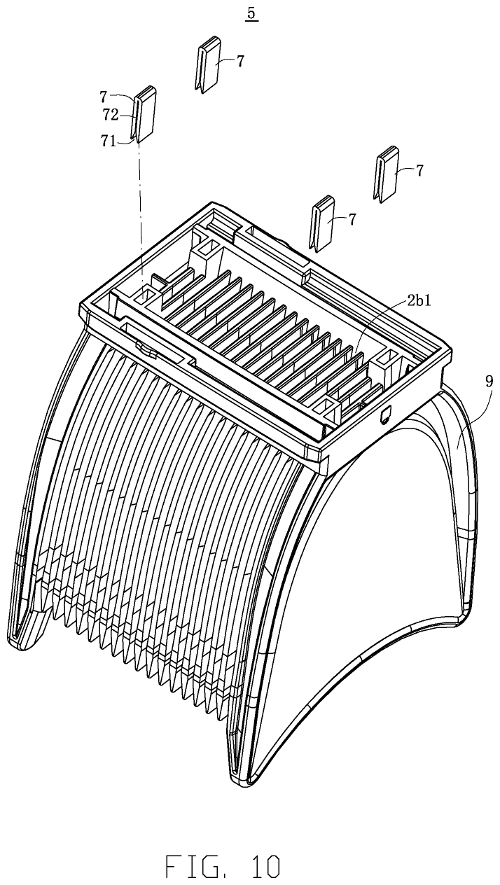

In a second solution, as shown in FIGS. 2 to 10, the model 1 includes stop blocks 7. The stop blocks 7 block the blades 33. The stop blocks 7 can be located on either the housing 9 or the base 5 of the model 1. For example, the stop blocks 7 can be located on the bottom of the housing 9, on the side walls 11, on the shielding walls 13, inside the first blade grooves 2a, inside the second blade grooves 2b, or on the base 5. As shown in FIGS. 2 to 5, the stop blocks 7 are located on the base 5. The stop blocks 7 are located outside the housing 9. The stop blocks 7 are cubic blocks. As shown in FIGS. 6 and 7, eight stop blocks 7 are located on the base 5. Four of the stop blocks 7 extend upward into the leftmost and rightmost second blade grooves 2b. The remaining four stop blocks 7 are located on the front and rear sides of the housing 9. As shown in FIGS. 9 and 10, the stop blocks 7 are inserted and fixed to the bottom of the housing 9. The stop blocks 7 extend upward into the leftmost and rightmost second blade grooves 2b.

In the second solution, when stop blocks 7 are located inside the second blade grooves 2b, the disposition effectively raises the bottoms of those second blade grooves 2b. For example, providing stop blocks 7 in the leftmost and rightmost second blade grooves 2b makes the bottoms of those second blade grooves 2b higher than the bottoms of the other second blade grooves 2b (which have no stop blocks 7). In case that the leftmost and rightmost blades of the blade set 3 enter the leftmost and rightmost second blade grooves 2b respectively, the leftmost and rightmost blades travel downward. When the leftmost and rightmost blades reach a position where the leftmost and rightmost blades are blocked by the bottoms of those second blade grooves 2b, the cutting edges of the other blades of the blade set 3 are suspended in respective second blade grooves 2b. The advantage of the second solution is that the bottoms of the leftmost and rightmost second blade grooves 2b are higher than the bottoms of the other second blade grooves 2b. Thus the bottoms of the leftmost and rightmost second blade grooves 2b can first block the leftmost and rightmost blades. The blocking suspends the cutting edges of the remaining blades in the corresponding second blade grooves 2b. The blocking prevents the cutting edges of the remaining blades from cutting into the bottoms of the other second blade grooves 2b.

In the above second solution, the number of stop blocks 7 can be one, two, three, four, or any other number. For example, in case that the number of stop blocks 7 is two, the two stop blocks 7 can be respectively located in the leftmost and rightmost first blade grooves 2a. Alternatively, the two stop blocks 7 can be located in the leftmost and rightmost second blade grooves 2b. In this case, when the blades of the blade set 3 move downward along the first blade grooves 2a, the stop blocks 7 block a part of the blades. The two leftmost and rightmost blades of the blade set 3 will respectively contact the two stop blocks 7. The contact prevents the blade set 3 from moving further downward.

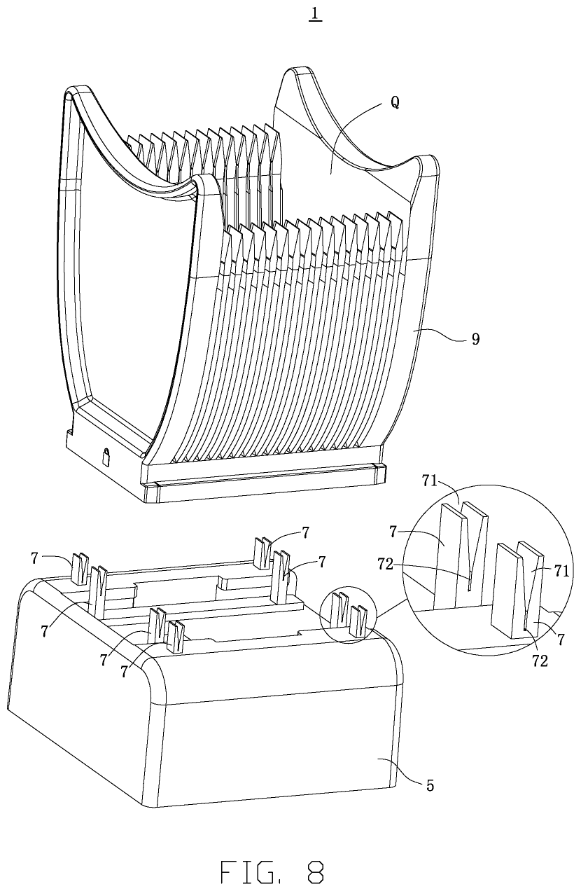

In the above second solution, as shown in FIGS. 8 and 10, the upper end of the stop block 7 may include a V-shaped notch 71. The V-shaped notch 71 guides the blades of the blade set 3 into position. The bottom of the V-shaped notch 71 may further include a slit 72. The slit 72 extends downward. The cutting edges of the blades of the blade set 3 can enter the slit 72. The entrance prevents the cutting edges from cutting into the stop block 7. The prevention further reduces the generation of plastic debris and improves safety and reliability.

It should be noted that in the description of the embodiments, the terms “front, back”, “left, right”, “inside, outside”, “upper, lower” and the like indicating directions or positional relationships are all based on the directions or positional relationships shown in the accompanying drawings, and are only for the convenience of describing the present disclosure and simplifying the description, rather than indicating or implying that the device or element referred to must have a specific direction, be constructed and operated in a specific direction, and therefore cannot be understood as a limitation on the present disclosure. The terms “install”, “connect”, and “connected” should be understood in a broad sense, for example, it can be a fixed connection, a detachable connection, or an integral connection; it can be a direct connection, or an indirect connection through an intermediate medium, or it can be a connection between the insides of two elements. For those of ordinary skill in the art, the specific meanings of the above terms in the present disclosure can be understood according to specific circumstances.

What is claimed is:

1. A meat slicer, comprising:
a blade set comprising a plurality of blades arranged side by side and at intervals;
a model comprising a placement cavity for accommodating meat, a first side wall, a second side wall opposite the first side wall, and a bottom connected to the first side wall and the second side wall, wherein the first side wall, the second side wall and the bottom comprise a plurality of blade grooves for receiving the plurality of blades respectively, and the plurality of blade grooves on the first side wall, correspond one-to-one with the blade grooves on the second side wall and the blade grooves on the bottom;
wherein the plurality of blades are configured to insert into the plurality of blade grooves on the first side wall and the second side wall and traveling downward into the plurality of blade grooves on the bottom, so as to cut meat placed in the placement cavity; and
the meat slicer is configured such that when the blade set travels downward to a position where a part of the plurality of blades abuts the model and cannot move further downward, cutting edges of another part of the plurality of blades are suspended in the corresponding blade grooves on the bottom.

2. The meat slicer according to claim 1, wherein said part of the plurality of blades are limiting blades, and said another part of the plurality of blades are cutting blades;
the cutting blades comprise cutting edges on one side; and
in case that the cutting edges of the cutting blades face horizontally downward, a horizontal height of the cutting edges of the cutting blades is higher than a horizontal height of corresponding same side edges of the limiting blades.

3. The meat slicer according to claim 2, wherein the limiting blades have no cutting edge.

4. The meat slicer according to claim 2, wherein the limiting blades and the cutting blades comprise cutting edges on the same side.

5. The meat slicer according to claim 1, wherein the model further comprises a stop block configured to abut said part of the plurality of blades, thereby suspending the cutting edges of said another part of the plurality of blades in the corresponding blade grooves on the bottom.

6. The meat slicer according to claim 5, wherein the number of said part of the plurality of blades is at least one.

7. The meat slicer according to claim 6, wherein the number of said part of the plurality of blades is at least two, and said part of the plurality of blades are located on both sides of said another part of the plurality of blades.

8. The meat slicer according to claim 5, wherein the model comprises a base and a housing;
the housing is configured to mount on the base;
the placement cavity, the first side wall, the second side wall and the plurality of blade grooves are defined on the housing; and
at least one of the base and the housing comprises the stop block.

9. The meat slicer according to claim 8, wherein the housing further comprises two shielding walls opposite each other, the shielding walls, the first side wall, the second side wall and the bottom together enclose the placement cavity, and the placement cavity has an open top;
the plurality of blade grooves on the first side wall and the second side wall are defined as first blade grooves, and the plurality of blade grooves on the bottom are defined as second blade grooves;
each of the plurality of second blade grooves communicates with a corresponding one of the plurality of first blade grooves; and
the stop block is located in at least one of: the first blade grooves, the second blade grooves, the shielding walls, and the base.

10. The meat slicer according to claim 5, wherein an upper end of the stop block comprises a V-shaped notch.

11. The meat slicer according to claim 10, wherein a bottom of the V-shaped notch comprises a slit extending downward.

12. A meat slicer, comprising:
a blade set comprising a plurality of strip-shaped metal pieces arranged side by side and at intervals, the plurality of strip-shaped metal pieces comprising:
a plurality of first metal pieces comprising cutting edges on one side for cutting food; and at least one second metal piece arranged side by side with the plurality of first metal pieces;
wherein, in case that the edges of the plurality of first metal pieces defining the cutting edges face horizontally downward, a horizontal height of the edges of the plurality of first metal pieces defining the cutting edges is higher than a horizontal height of the same side edges of the at least one second metal piece.

13. The meat slicer according to claim 12, wherein the at least one second metal pieces are located on both sides of the plurality of first metal pieces.

14. The meat slicer according to claim 12, wherein the at least one second metal piece has no cutting edge.

15. The meat slicer according to claim 12, wherein, in case that the edges of the plurality of first metal pieces defining the cutting edges are in a horizontal state, the side of each first metal pieces opposite the cutting edge and the corresponding side of the second metal piece are at a same horizontal level.

16. A meat slicer, comprising:
a model for accommodating meat, the model defining a placement cavity, the placement cavity defining an open top and two opposite side walls, each of the two opposite side walls comprising a plurality of blade grooves spaced apart; and
a blade set comprising:
a first handle comprising a recess;
a first blade holder connected to the first handle, the first blade holder carrying a first set of blades arranged side by side and at intervals;
a second blade holder engageable with the first blade holder, the second blade holder carrying a second set of blades arranged side by side and at intervals, the second set of blades being parallel to the first set of blades; and
a second handle connected to the second blade holder;
wherein, in a state where the second blade holder is engaged with the first blade holder, the second handle is received in the recess, and each blade of the second set of blades is located between two adjacent blades of the first set of blades; and longitudinal central axes of the blade set, the first handle and the second handle coincide with each other.

17. The meat slicer according to claim 16, wherein the first handle comprises a locking block configured to slide back and forth along a length direction of the first handle, a front end of the locking block comprising a locking tab;
the second handle comprises a locking hole; and
the locking tab is insertable into or withdrawable from the locking hole to lock or unlock correspondingly the first handle and the second handle.

18. The meat slicer according to claim 17, wherein the first handle further comprises a first elastic member; and
two ends of the first elastic member respectively abut the first handle and the locking block, causing the locking block to move forward.

19. The meat slicer according to claim 18, wherein the recess comprises a pop-up structure;
the pop-up structure comprises a pop-up block and a second elastic member, the pop-up block being constrained in the recess and movable up and down along a thickness direction of the first handle; and
a lower end of the second elastic member abuts the first handle, an upper end of the second elastic member acts on the pop-up block, and the pop-up block is configured to act on the second handle to push the second handle out of the recess, so as to separate the second blade holder from the first blade holder.

20. The meat slicer according to claim 16, wherein the blade set further comprises a first connecting block and a second connecting block;
the first set of blades have proximal ends connected to the first blade holder and distal ends connected to the first connecting block; the second set of blades have proximal ends connected to the second blade holder and distal ends connected to the second connecting block; and the first connecting block and the second connecting block are engaged with each other;
a first lower end surface of the first blade holder extends upward to form a plurality of first upper ribs arranged and at intervals, a second lower end surface of the first connecting block extends upward to form a plurality of second upper ribs arranged at intervals, the proximal ends of the first set of blades are connected to corresponding ones of the plurality of first upper ribs, and the distal ends of the first set of blades are connected to corresponding ones of the plurality of second upper ribs;
a first upper end surface of the second blade holder extends downward to form a plurality of first lower ribs arranged and at intervals, a second upper end surface of the second connecting block extends downward to form a plurality of second lower ribs arranged and at intervals, the proximal ends of the second set of blades are connected to corresponding ones of the plurality of first lower ribs, and the distal ends of the second set of blades are connected to corresponding ones of the plurality of second lower ribs; and
the plurality of first lower ribs are inserted between adjacent two of the first upper ribs to achieve engagement of the first blade holder and the second blade holder, and the plurality of second lower ribs are inserted between adjacent two of the second upper ribs to achieve engagement of the first connecting block and the second connecting block.

21. The meat slicer according to claim 20, the second blade holder further comprises a plurality of first reinforcing ribs between two adjacent first lower ribs, and the second connecting block further comprises a plurality of second reinforcing rib between two adjacent second lower ribs.
